(19) United States
(12) Patent Application Publication
(10) Pub. No.: US 2011/0001386 A1
(43) Pub. Date: Jan. 6, 2011

(54) MOTOR AND ELECTRONIC APPARATUS USING THE SAME

(75) Inventors: Hiroaki KAWASAKI, Osaka (JP); Yuichi YOSHIKAWA, Osaka (JP); Atsuyoshi KOSHIBA, Hyogo (JP); Yasuhiro INOUE, Tottori (JP); Koji KADOWAKI, Tottori (JP); Yasuo KUNISHIGE, Tottori (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/827,546

(22) Filed: Jun. 30, 2010

(30) Foreign Application Priority Data
Jul. 6, 2009 (JP) 2009-160000

(51) Int. Cl. H02K 1/14

(52) U.S. Cl. 310/216.064

(57) ABSTRACT

A stator 3 is provided with a plurality of magnetic poles 3a on the outer circumference thereof, and is configured from a plurality of layers of plate-shaped members. A rotor 4 is rotatably disposed around the stator. The inner circumferential face of the rotor is provided with a magnet 5. The outer circumferential ends of the magnetic poles of the stator are provided with an extended portion that is bent such that at least one plate-shaped member, including an outermost layer, of the plurality of plate-shaped members is substantially parallel to the magnet. When a thickness of a thinnest plate-shaped member of the at least one plate-shaped member constituting the extended portion is taken as T1, and a thickness of a thinnest plate-shaped member of a plate-shaped member not constituting the extended portion is taken as T2, T1 >T2 is satisfied. Accordingly, it is possible to improve the driving efficiency of an outer rotor-type motor.

### BACKGROUND OF THE INVENTION

1. Field of the Invention

The present invention relates to a motor and an electronic apparatus using the same.

2. Description of the Related Art

In electronic apparatuses such as laser printers, a paper feed roller (driven member) provided in a main body case is coupled via a deceleration mechanism to a driving shaft of a motor. When this motor is driven, the paper feed roller rotates and feeds paper to a predetermined portion.

As this motor, a brushless DC motor that ordinarily is used includes: a stator on whose outer circumference a plurality of magnetic poles are arranged at a first predetermined interval; and a rotor that is rotatably disposed around the stator. An inner circumferential face of the rotor is provided with a magnet magnetized to have opposite polarities at a second predetermined interval.

In this sort of motor, ordinarily, in order to arrange the magnet of the rotor as close as possible to a magnetism-detecting element that magnetically detects rotation of the rotor, the size of the magnet in a direction parallel to a motor-driving shaft is set larger than the size of a magnetic pole base of the stator in the same direction. In this case, an extended portion that extends in a direction substantially parallel to the magnet often is formed on both sides of a magnetic pole base, at outer circumferential ends of the magnetic poles of the stator (see JP H9-285044A and JP 2007-244004A, for example). Accordingly, the area in which the magnet of the rotor and the magnetic poles of the stator oppose each other increases, and, thus, the driving force and the driving efficiency of the motor can be increased.

The extended portion has an effect of causing magnetic fluxes from the magnet to flow thereinto, and, thus, more magnetic fluxes from the magnet can be directed to the magnetic poles of the stator in the case where the extended portion is provided than in the case where no extended portion is provided. Accordingly, it is considered that the driving force and the driving efficiency can be increased by forming an extended portion at outer circumferential ends of the magnetic poles of the stator.

However, according to investigations of the present inventors, the driving force cannot be necessarily increased simply by providing an extended portion.

The extended portion ordinarily is formed by bending a plate-shaped member constituting the stator so as to be substantially parallel to the magnet. Magnetic fluxes from the magnet flowing into the extended portion pass through this bent portion. However, due to a processing strain that occurs during this bending processing, a magnetic properties-deteriorated region is formed in the bent portion. In this magnetic properties-deteriorated region, magnetic saturation easily occurs. When magnetic saturation occurs, iron loss increases. As a result, the driving force and the driving efficiency cannot be improved.

### SUMMARY OF THE INVENTION

It is an object of the present invention to solve the above-described problem, by improving the driving efficiency of a motor.

The present invention is directed to a motor, including: a stator on whose outer circumference a plurality of magnetic poles are arranged at a first predetermined interval in a circumferential direction; and a rotor that is rotatably disposed around the stator. An inner circumferential face of the rotor is provided with a magnet magnetized to have opposite polarities at a second predetermined interval in a circumferential direction. The stator is configured from a plurality of layers of plate-shaped members. Each of outer circumferential ends of the plurality of magnetic poles is provided with an extended portion that is bent such that at least one plate-shaped member, including an outermost layer, of the plurality of plate-shaped members is substantially parallel to the magnet. Then, when a thickness of a thinnest plate-shaped member of the at least one plate-shaped member constituting the extended portion is taken as T1, and a thickness of a thinnest plate-shaped member of a plate-shaped member not constituting the extended portion is taken as T2, T1>T2 is satisfied.

The present invention is directed to an electronic apparatus, including: a main body case; a driven member that is provided in the main body case; and a motor that is coupled to the driven member; wherein the motor is the motor according to the present invention.

### BRIEF DESCRIPTION OF THE DRAWINGS

FIG. 1 is a cross-sectional view showing the schematic configuration of a motor according to an embodiment of the present invention.

FIG. 2 is a perspective view showing the schematic configuration of a stator constituting the motor according to the embodiment of the present invention.

FIG. 3 is a front view showing the schematic configuration of the stator constituting the motor according to the embodiment of the present invention.

FIG. 4 is a view showing magnetic properties-deteriorated regions formed in a bent portion of an extended portion.

FIG. 5 is a view showing magnetic properties-deteriorated regions formed in a bent portion of an extended portion in a conventional motor.

FIG. 6 is a view showing magnetic properties-deteriorated regions formed in a bent portion of an extended portion in a motor according to the embodiment of the present invention.

FIG. 7 is a graph showing the relationship between the silicon content and the stretch ratio of a silicon steel plate.

FIG. 8 is a diagram showing the schematic configuration of an example of an electronic apparatus using the motor of the present invention.

### DESCRIPTION OF THE PREFERRED EMBODIMENTS

According to the present invention, when the thickness of the thinnest plate-shaped member among plate-shaped members constituting the extended portion is taken as T1, and the thickness of the thinnest plate-shaped member among plate-shaped members not constituting the extended portion is taken as T2, T1>T2 is satisfied, and, thus, the thickness of a region where magnetic properties do not deteriorate in the bent portion of the extended portion can be increased. Accordingly, even when the amount of magnetic fluxes passing through the bent portion is increased by providing the extended portion, the occurrence of magnetic saturation in the bent portion can be suppressed, and the iron loss can be reduced. As a result, the driving efficiency of the motor can be improved.

Hereinafter, the present invention will be described in detail using preferred embodiments. Here, it will be appreciated that the present invention is not limited to the following embodiments.

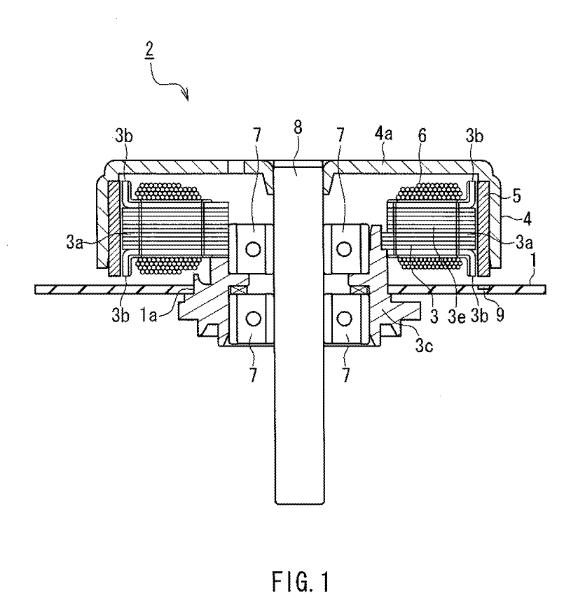

FIG. 1 is a cross-sectional view showing the schematic configuration of a motor 2 according to an embodiment of the present invention. As shown in FIG. 1, the motor 2 of this embodiment is mounted on a wiring board (substrate) 1 of an electronic apparatus (e.g., a laser printer). The wiring board 1 is provided horizontally in a main body case (not shown) constituting the electronic apparatus.

In the description below, the direction of a driving shaft 8 of the motor 2 is taken as a vertical direction, and the upper side and the lower side in the section of the diagram of FIG. 1 are referred to respectively as an “upper side” and a “lower side” of the motor 2.

The motor 2 includes a stator 3 that is mounted via a holding portion 3c on the wiring board 1, and a rotor 4 that is disposed around the stator 3. The rotor 4 is in the shape of a cylinder, the upper end thereof has a top plate 4a fixed thereto, and the lower end thereof is open. The inner circumferential face of the holding portion 3c is provided with a plurality of bearings 7. The driving shaft 8 of the motor 2 passes through the plurality of bearings 7, and the upper end of the driving shaft 8 is fixed to the top plate 4a of the rotor 4. As a result, the rotor 4 and the driving shaft 8 are freely rotatable with respect to the stator 3 via the bearings 7. The lower end of the driving shaft 8 passes through a through-hole 1a of the wiring board 1, and extends downward from the wiring board 1.

A magnet 5 in the shape of a ring is fixed to the inner circumferential face of the rotor 4. A face of the magnet 5 opposing the stator 3 is magnetized (main magnetization) such that an N-pole and an S-pole are formed alternately (such that adjacent poles have opposite polarities) at a predetermined interval in the circumferential direction. The direction of the main magnetization is in a direction opposing the stator 3 (radial direction).

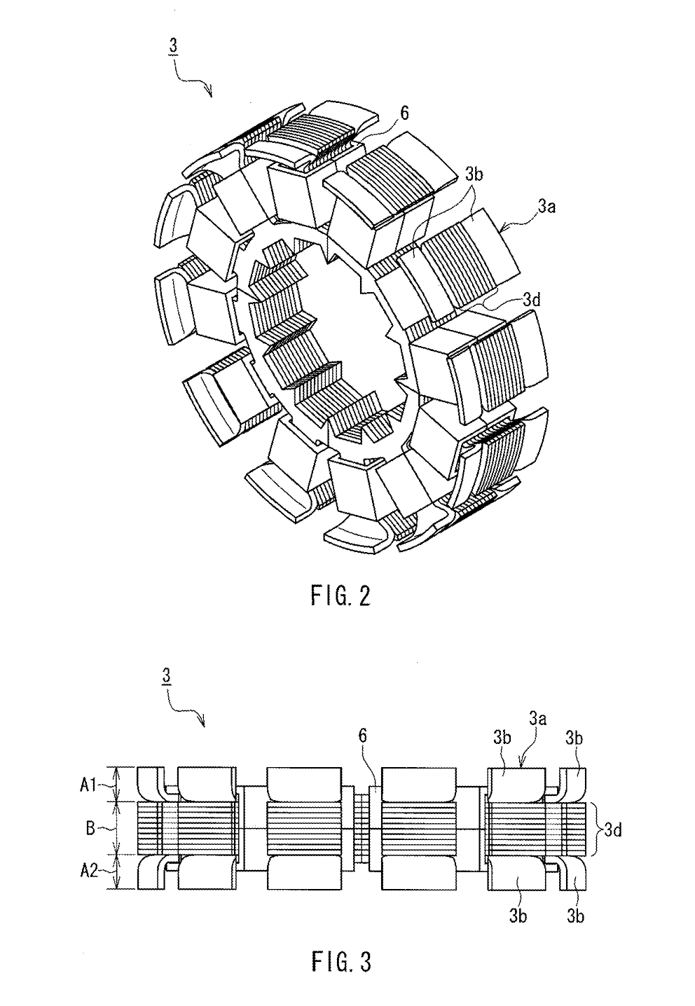

FIG. 2 is a perspective view of the stator 3. FIG. 3 is a front view of the stator 3. The stator 3 includes a layered member in which a plurality of plate-shaped members (e.g., thin steel plates having a high magnetic permeability) are layered. A plurality of magnetic poles 3a are arranged at a predetermined interval in the circumferential direction on the outer circumference of the stator 3 (see FIG. 2). A coil 6 for an electromagnet is wound about a magnetic path 3e (see FIG. 1) that is a portion where a magnetic circuit is formed on the inner side of each magnetic pole 3a. When an AC power is applied to the coil 6, each magnetic pole 3a is magnetized to have a N-polarity and a S-polarity alternately. Accordingly, attraction or repulsion is generated between the magnetic pole 3a and the magnet 5 opposing each other, the rotor 4 rotates about the driving shaft 8, and a rotational driving force is output via the driving shaft 8.

Returning to FIG. 1, a Hall IC 9 is mounted as a magnetism-detecting element at a point of the wiring board 1 opposing the lower end face of the magnet 5.

With a well known method, the Hall IC 9 is used to detect the rotational speed and the rotational amount of the rotor 4, thereby controlling the rotations.

In order to arrange the magnet 5 as close as possible to the Hall IC 9, the lower end of the magnet 5 (end portion on the wiring board 1 side) is extended downward to near the Hall IC 9. Furthermore, in order to avoid deterioration of balance with the stator 3 caused because the lower end of the magnet 5 is extended downward, the upper end of the magnet 5 also is extended upward by the same amount.

As a result, the vertical size of the magnet 5 increases. In accordance with this increase, the outer circumferential end of each magnetic pole 3a of the stator 3 is provided with extended portions 3b that respectively extend from a central magnetic pole base 3d to the wiring board 1 side (lower side) and to the top plate 4a side (upper side). The extended portions 3b are substantially parallel to the magnet 5, that is, substantially parallel to the axial direction of the driving shaft 8.

The extended portions 3b are formed by bending an outer circumferential portion of at least one plate-shaped member, including the outermost layer (the uppermost layer or the lowermost layer), of a plurality of layers of plate-shaped members constituting the stator 3 upward or downward at a substantially right angle so as to be substantially parallel to the magnet 5.

In the present invention, when the thickness of the thinnest plate-shaped member among plate-shaped members constituting the extended portion 3b is taken as T1, and the thickness of the thinnest plate-shaped member among plate-shaped members not constituting the extended portion (i.e., plate-shaped members constituting the magnetic pole base 3d) is taken as T2, T1>T2 is satisfied. The effect obtained by this configuration will be described below.

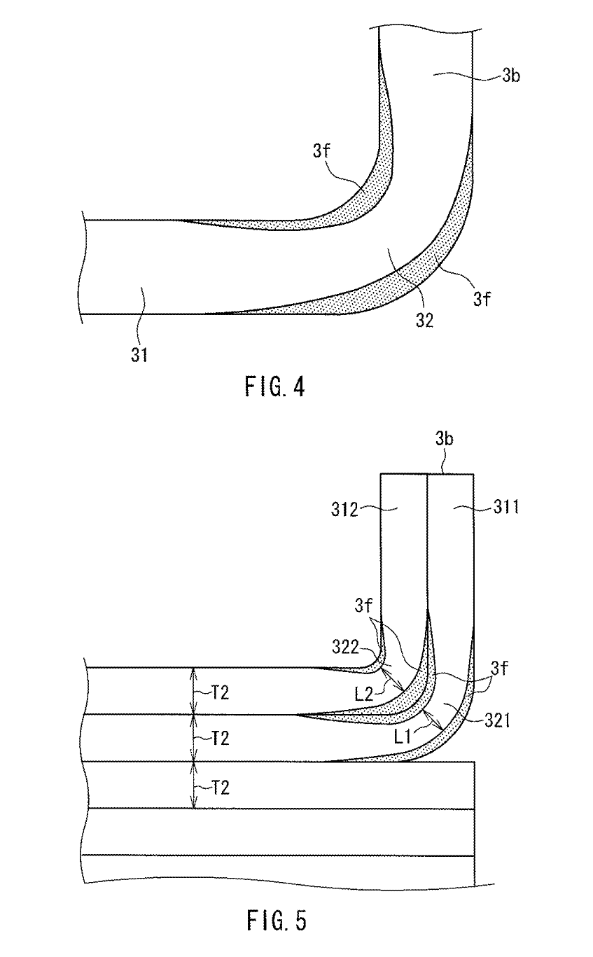

In the case where a plate-shaped member is bent in order to form the extended portion 3b, as shown in FIG. 4, according to a processing strain that occurs in a bent portion 32 of a plate-shaped member 31 during the bending processing, magnetic properties-deteriorated regions 3f are formed at the surfaces of the bent portion 32 on the inner circumferential side and the outer circumferential side. In the magnetic properties-deteriorated regions 3f, magnetic saturation easily occurs. When magnetic saturation occurs, iron loss increases. As a result, the driving force and the driving efficiency cannot be improved. Furthermore, in the case where the extended portion 3b is formed, more magnetic fluxes flow into the plate-shaped member 31 constituting the extended portion 3b, and, thus, magnetic saturation in the bent portion 32 more easily occurs.

FIG. 5 is a view showing the vicinity of the extended portion 3b in a conventional motor. In FIG. 5, the extended portion 3b is formed by bending two plate-shaped members 311 and 312, including the outermost layer, of the plurality of plate-shaped members constituting the stator 3. All of the plurality of plate-shaped members constituting the stator 3, including the two plate-shaped members 311 and 312 constituting the extended portion 3b, have a same thickness T2.

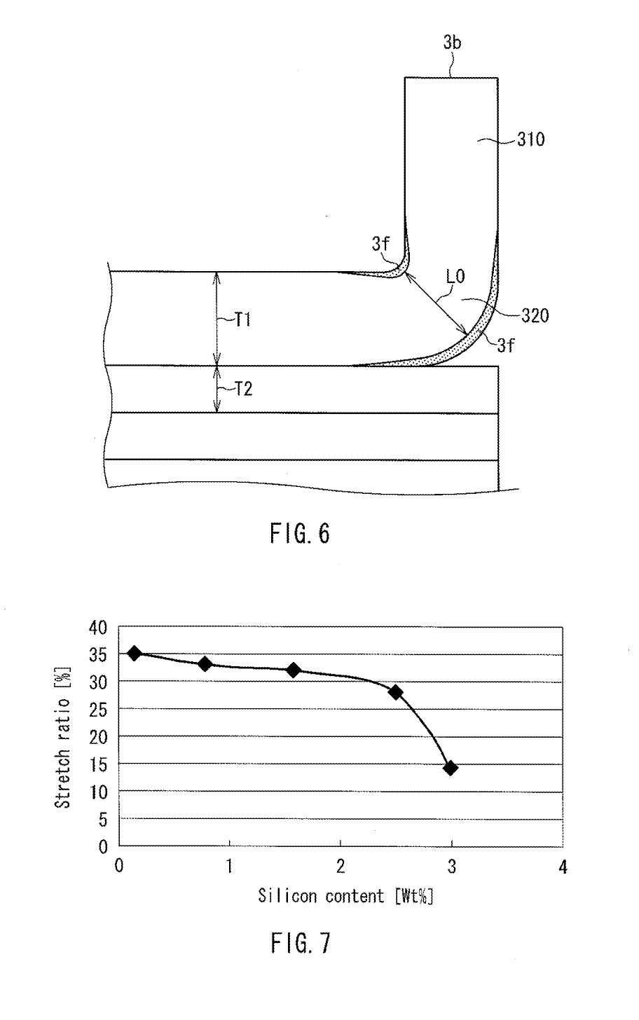

FIG. 6 is a view showing the vicinity of the extended portion 3b in the motor of this embodiment. In FIG. 6, the extended portion 3b is formed by bending only one outermost plate-shaped member 310 of the plurality of plate-shaped members constituting the stator 3. The plate-shaped member 310 constituting the extended portion 3b has a thickness T1. All of plate-shaped members not constituting the extended portion (i.e., plate-shaped members constituting the magnetic pole base 3d) have the same thickness T2. In order to simplify the description, it is assumed that T1=T2×2 in this example.

The total thickness of the two plate-shaped members 311 and 312 constituting the extended portion 3b in the conventional motor shown in FIG. 5 and the thickness of the one plate-shaped member 310 constituting the extended portion 3b in the motor of the present invention shown in FIG. 6 are the same (T1). When the thicknesses of regions where magnetic properties do not deteriorate in bent portions 321 and 322 of the two plate-shaped members 311 and 312 constituting the extended portion 3b in FIG. 5 are taken as L1 and L2, and the thickness of a region where magnetic properties do not deteriorate in a bent portion 320 of the one plate-shaped member 310 constituting the extended portion 3b in FIG. 6 is taken as L0, the thicknesses of the magnetic properties-deteriorated regions 3f formed at the surfaces of the bent portions 320, 321, and 322 of the plate-shaped members 310, 311, and 312 are substantially the same regardless of the thicknesses T1 and T2 of the plate-shaped members 310, 311, and 312, and, thus, L0>L1+L2 is obtained.

As easily seen from the description above, since T1>T2 is satisfied, the thickness of a region where magnetic properties do not deteriorate in the bent portion 320 of the extended portion 3b can be increased. In the case where the extended portion 3b is formed, a large amount of magnetic fluxes flow into the plate-shaped member 310 constituting the extended portion 3b, pass through the bent portion 320, and proceed to the magnetic path 3e (see FIG. 1). According to the present invention, a larger region where magnetic properties do not deteriorate can be secured in the bent portion 320. Thus, even when a large amount of magnetic fluxes flow into the plate-shaped member 310 constituting the extended portion 3b, the occurrence of magnetic saturation in the bent portion 320 can be suppressed, and the iron loss can be reduced. As a result, the driving efficiency can be improved.

Here, in the case where the thickness T1 of the thinnest plate-shaped member among plate-shaped members constituting the extended portion 3b is too large, eddy current loss that occurs at that plate-shaped member increases. Accordingly, it is preferable that 2×T2≧T1 is satisfied.

In FIG. 6, the extended portion 3b is configured from only one outermost plate-shaped member 310 of the plurality of plate-shaped members constituting the stator 3, but the present invention is not limited to this. For example, the extended portion may be configured from two or more plate-shaped members including the outermost layer. Here, in the case where the extended portion 3b is configured from only one plate-shaped member, processing non-uniformity of the extended portion 3b during production can be suppressed more than in the case where the extended portion 3b is configured from a plurality of plate-shaped members, and, thus, the properties of the motor are more stable. In addition, since the number of molds for bending and forming plate-shaped members having the extended portion 3b can be reduced, the cost also can be reduced. That is to say, in the case where the extended portion 3b is configured from one thick plate-shaped member having the thickness T1 that satisfies T1>T2, improvement in the driving efficiency of the motor, stabilization of quality, and reduction of the production cost can be realized simultaneously.

In the case where the extended portion 3b is configured from two or more plate-shaped members, T1 described above is defined to be the thickness of the thinnest plate-shaped member of the two or more plate-shaped members constituting the extended portion 3b. The reason for this is that the focus is on magnetic saturation of magnetic fluxes passing through each plate-shaped member in the present invention. For the same reason, T2 described above is defined to be the thickness of the thinnest plate-shaped member of a plurality of plate-shaped members not constituting the extended portion (i.e., a plurality of plate-shaped members constituting the magnetic pole base 3d).

In the case where a plate-shaped member is bent in order to form the extended portion 3b, the outer circumferential side of the bent portion is stretched more than the inner circumferential side. Accordingly, when the allowable stretch ratio of the plate-shaped member is small, the outer circumferential side of the bent portion is deformed plastically and broken. A silicon steel plate (also referred to as an electromagnetic steel plate) ordinarily is used as plate-shaped members constituting the stator 3. The stretch ratio of this material varies according to a silicon content S as shown in FIG. 7. If the silicon content S is more than 2.5 wt %, the stretch ratio is sharply reduced. Accordingly, it is preferable that the silicon content S of a plate-shaped member constituting the extended portion 3b satisfies S≦2.5 wt %.

As described above, according to the present invention, occurrence of magnetic saturation in a bent portion is suppressed by configuring the extended portion 3b from a relatively thick plate-shaped member. However, in the case where the area of the extended portion 3b opposing the magnet 5 is too large, the amount of magnetic fluxes flowing from the magnet 5 into the extended portion 3b increases, and, thus, magnetic saturation occurs in the magnetic path 3e (see FIG. 1) about which the coil 6 is wound. In the case where magnetic saturation occurs in the magnetic path 3e, even when electrical power applied to the coil 6 is increased, the rotational torque of the rotor 4 does not proportionally increase, and the driving efficiency deteriorates. Thus, when, as shown in FIG. 3, the total length of the extended portions 3b that are vertically arranged on each magnetic pole 3a in the axial direction of the driving shaft 8 is taken as A1+A2, and the length of the magnetic pole 3a excluding the extended portions 3b in the same direction (i.e., the length of the magnetic pole base 3d in the same direction) is taken as B, it is preferable that A1+A2≦B is satisfied. Accordingly, the occurrence of magnetic saturation in the magnetic path 3e can be prevented, and deterioration of the driving efficiency can be avoided. Here, in FIG. 3, the length A1 of the extended portion 3b that is formed on the upper side of the magnetic pole 3a and the length A2 of the extended portion 3b that is formed on the lower side ordinarily are set to be the same.

Ordinarily, the gap between the inner face of the magnet 5 on the rotor 4 and an electrode 3a of the stator 3 is extremely small, for example, approximately 0.3 mm. Accordingly, it is preferable that the bending angle of a plate-shaped member constituting the extended portion 3b is increased (i.e., the bending angle is slightly larger than 90 degrees) such that the tip end (i.e., the upper end or the lower end) of the extended portion 3b is disposed closer to the inner side of the stator 3 than the bent portion at the root of the extended portion 3b is disposed (i.e., the extended portion 3b is positioned on the driving shaft 8 side). Accordingly, it is possible to avoid a danger that the extended portion 3b will be displaced by some stress toward the magnet 5 in a long term of use, and brought into contact with the rotor 4.

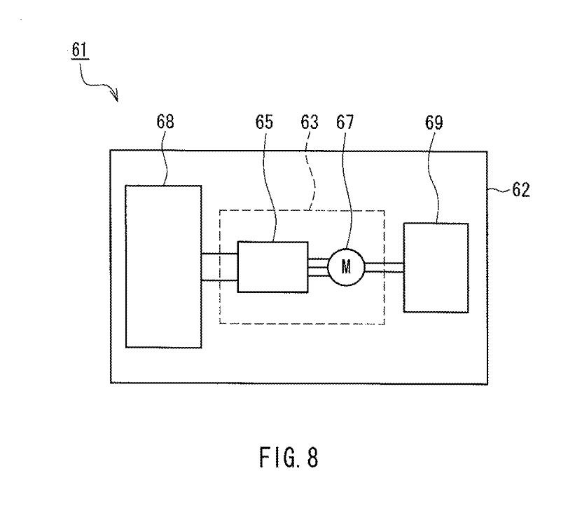

FIG. 8 is a diagram showing the schematic configuration of an example of an electronic apparatus using the motor of the present invention. In FIG. 8, an electronic apparatus 61 includes a casing 62 that functions as a main body case, a motor 67 mounted inside the casing 62, a driving unit 65 for driving the motor 67, a power source 68 for supplying electricity to the driving unit 65, and a load (driven member) 69 such as a mechanism portion that is driven using the motor 67 as a power source. Here, the motor 67 and the driving unit 65 constitute a motor drive apparatus 63. The motor 67 is driven by electrical power supplied from the power source 68 via the driving unit 65. A rotational torque is transmitted via the driving shaft of the motor 67 to the load 69. The motor 2 of the present invention can be used as the motor 67.

For example, a laser printer can be given as an example of the electronic apparatus 61. In this case, a paper feed roller corresponds to the load 69. The motor 2 of the present invention shown in FIG. 1 may be mounted together with various electronic components on the wiring board 1 that is horizontally provided in a main body case of the laser printer. In the motor 2, a gear (not shown) can be fixed to a lower portion of the driving shaft 8 that passes through the wiring board 1 and extends downward, and this gear and a gear provided at the paper feed roller can be coupled to each other via a gearbox (not shown) functioning as a deceleration mechanism. The motor 2 of the present invention has a high driving efficiency, and, thus, a laser printer can be realized that can feed paper efficiently.

According to the present invention, it is possible to provide an outer rotor-type motor that has an improved driving efficiency. Thus, the present invention is preferable, for example, for a motor that is used in electronic apparatuses such as laser printers, laser copiers, and the like. Here, the motor of the present invention is not limited to these, and can be used widely as a motor that is required to have a high driving efficiency.

The embodiments described above are solely intended to elucidate the technological content of the present invention, and the present invention is not limited to or by these specific examples alone. Various modifications are possible within the spirit of the invention and the scope of the claims, and the present invention should be interpreted broadly.

1. A motor, comprising:
a stator on whose outer circumference a plurality of magnetic poles are arranged at a first predetermined interval in a circumferential direction; and
a rotor that is rotatably disposed around the stator;
wherein an inner circumferential face of the rotor is provided with a magnet magnetized to have opposite polarities at a second predetermined interval in a circumferential direction,
the stator is configured from a plurality of layers of plate-shaped members,
each of outer circumferential ends of the plurality of magnetic poles is provided with an extended portion that is bent such that at least one plate-shaped member, including an outermost layer, of the plurality of plate-shaped members is substantially parallel to the magnet, and
when a thickness of a thinnest plate-shaped member of the at least one plate-shaped member constituting the extended portion is taken as T1, and a thickness of a thinnest plate-shaped member of a plate-shaped member not constituting the extended portion is taken as T2, T1>T2 is satisfied.

2. The motor according to claim 1, wherein the extended portion is configured from only one plate-shaped member.

3. The motor according to claim 1, wherein a silicon content S of a plate-shaped member constituting the extended portion satisfies S≦2.5 wt %.

4. The motor according to claim 1, wherein 2×T2≧T1 is satisfied.

5. The motor according to claim 1,
wherein the extended portion is formed on both sides of each of the plurality of magnetic poles, and
a total length of the extended portions on both sides in a direction of a driving shaft fixed to the rotor is not greater than a length of the magnetic pole excluding the extended portions in the direction.

6. The motor according to claim 1, wherein a tip end of the extended portion is disposed closer to an inner side of the stator than a bent portion at a root of the extended portion is disposed.

7. An electronic apparatus, comprising:
a main body case;
a driven member that is provided in the main body case; and
a motor that is coupled to the driven member;
wherein the motor is the motor according to claim 1.

8. The electronic apparatus according to claim 7,
wherein a wiring board is provided in the main body case,
the motor is attached to the wiring board, and a magnetism-detecting element is provided on the wiring board so as to oppose the magnet of the motor.
